(19) United States
(12) Patent Application Publication
(10) Pub. No.: US 2004/0102960 A1
(43) Pub. Date: May 27, 2004

(54) Process and system for generating knowledge code and converting knowledge code into text

(76) Inventors: Yoshiki Shimomura, Tokyo-to (JP); Yutaka Nomaguchi, Suita-shi (JP); Ichiro Koike, Nagoya-shi (JP); Noriyasu Goto, Nagoya-shi (JP)

Correspondence Address: POSZ & BETHARDS, PLC, 11250 ROGER BACON DRIVE, SUITE 10, RESTON, VA, 20190, US

(21) Appl. No.: 10/716,557

(22) Filed: Nov. 20, 2003

(30) Foreign Application Priority Data
Nov. 22, 2002 (JP) 2002-338832
Aug. 29, 2003 (JP) 2003-305667

(51) Int. Cl. G06F 17/27

(52) U.S. Cl. 704/9

(57) ABSTRACT

A process and a system for generating a knowledge code based on a text described in a natural language and converting the generated knowledge code into the text. The process includes the steps of preparing a text described in a natural language by means of a text describing assistant system, converting the text into an intermediate knowledge code, converting the intermediate knowledge code into the knowledge code, and inputting the knowledge code into a knowledge-based system. The text describing assistant system describes the text using a text generation tool by inputting describing items in accordance with a previously provided text description procedure. The conversion of the knowledge code into the text is performed by converting the outputted knowledge code into the intermediate knowledge code using an intermediate knowledge code converting unit, and converting the intermediate knowledge code into the text using a document description generating unit.

### CROSS-REFERENCE TO RELATED APPLICATIONS

This application is related to and claims priority from Japanese patent applications Nos. 2002-338832 and 2003-305667, incorporated herein by reference.

### BACKGROUND OF THE INVENTION

1. Field of the Invention

The present invention relates to a process and system for generating a knowledge code used for knowledge-based system, including preparation of a text using a text description assistance system, automatic conversion of the text into a knowledge code, and reconversion of the converted knowledge codes into text, for example, automatic conversion of design document such as component production procedure document into CAD knowledge code and reconversion of the CAD knowledge code into the design document when designing of the component is performed using the knowledge-based CAD.

2. Description of Related Art

Recently, efforts for executing efficient and high level operations has been made in various fields using the knowledge-based system. For example, a knowledge-based system, a design assistance system which holds knowledge and know-how which designers have for the purpose of making the design operation more efficient for implementing a semi-automatic design has been developed (refer to JP-A-Hei 11-296566). When such a knowledge-based system is utilized, conversion of knowledge on a text which is written in a natural language used for the same into a knowledge code has been separately achieved in respective knowledge-based systems.

In case of a product design in prior art design work, design standards which specify the requirements of the product and an appearance design aspect which specifies the requirements of the appearance design are determined at the upstream stage of the design process as shown in FIG. 1. In order to meet the requirements, the designers prepare a design procedure document which describes the dimensions and shape of the product and their determining process in a natural document as a design language with reference to drawings of similar products which were designed in the past. At the final stage, CAD operators prepare a CAD model of the product by applying the design document to the appearance design aspect on the CAD.

The design procedure document which is a design document explicitly describes design rules and design procedure which are necessary to satisfy the required specifications which are described in the design standards, since the design procedure document gives distinct instructions to the CAD operators and is used for sharing and reutilization of knowledge on the design rules and design procedure among the designers, it is written in a natural language. Conversion of the text of the design rules and design procedure document into CAD knowledge codes makes it possible to perform the CAD model forming work by support of knowledge-based modeling function of the knowledge-based CAD.

Introduction of the knowledge-based CAD to this product design process adds a step for preparing CAD knowledge codes based upon the design procedure document as shown in FIG. 2 to a prior art process shown in FIG. 1. Since this design procedure document is prepared by the designers based upon their own knowledge and experiences, omissions of words may occur and/or individual wording may be different, so that representation is not necessarily uniform when the CAD knowledge codes of the knowledge-based CAD are prepared.

However, knowledge relating to coding of the CAD codes corresponding to respective knowledge based CAD is necessary in order to prepare CAD codes. Learning of respective CAD codes is a great burden upon CAD operators.

Representation formats of CAD codes are not generally convertible among knowledge-based CADs. Therefore, if a person who uses CAD data has a different knowledge-based CAD, he or she has to perform reencoding of CAD codes corresponding to the knowledge based CAD based upon component production procedure document when he or she changes the knowledge-based CADs. It is time consuming, inefficient, so that there is a problem from a viewpoint of reutilization of the knowledge.

Information on the designing rules and design procedure which is converted into CAD knowledge codes is difficult for its utilization and maintenance by a third party if it remains as knowledge coded. However, check, maintenance and documentation of the information is necessary for the advance of technology and utilization of the design information. In other words, confirmation and verification of input design knowledge, updating of design knowledge and retrieval of design knowledge is necessary to check and maintain the design rules and design procedure. Making documents which are easy for a third party to understand has become necessary in order for a number of designers to commonly use the knowledge as design standards. Since the knowledge codes are symbolized, they are difficult to recognize, so that reconversion of them into a natural language has been required. Therefore, efficient preparation of knowledge codes is needed for efficient use of a knowledge-based system.

### BRIEF SUMMARY OF THE INVENTION

It is an object of the present invention to provide a process and a system for generating a knowledge code in which the knowledge code is easily prepared based upon a text which is written in a natural language, for example a design document (component production procedure document and the like) without learning knowledge codes for each knowledge-based system and mutual exchange between different knowledge codes is easy.

It is another object of the present invention to provide a process and system for generating a knowledge code in preparation and reconversion of the knowledge code is easy based upon a text which is written in a natural language, for example, a design document (component production procedure document and the like) and mutual exchange between different knowledge codes is easy without learning the format of knowledge code for each knowledge-based system.

According to a first aspect of the invention, the process for generating a knowledge code which is used in a knowledge-based system comprises the steps of converting a text which is described in a natural language into a knowledge code and inputting the knowledge code into the knowledge-based system. The step of converting the text into the knowledge code comprises the steps of preparing an intermediate knowledge code which represents knowledge of an object field and does not depend on the knowledge-based system, from the description of the text which is described in a natural language in accordance with intermediate knowledge code generating rules and converting the intermediate knowledge code into the knowledge code which can be used in the knowledge-based system in accordance with the knowledge code generating rules.

In accordance with the first aspect of the invention, the text described in a natural language can be smoothly converted into the knowledge code via the intermediate knowledge code irrespective of the knowledge-based system. Conversion of the knowledge code into the other knowledge code corresponding to different knowledge-based system becomes easier.

According to a second aspect of the invention, the process for generating a knowledge code which is used in a knowledge-based CAD, comprises the steps of converting a design document into a knowledge code and inputting the knowledge code into the knowledge-based CAD. The step of converting the design document into the knowledge code comprises the steps of preparing an intermediate knowledge code which represents knowledge of a design object field and does not depend upon the knowledge-based CAD, from the description of the design document which is described in a natural language in accordance with intermediate knowledge code generating rules and converting the intermediate knowledge code into the knowledge code in accordance with the knowledge code generating rules.

In accordance with the second aspect of the invention, conversion of the design document into the knowledge code corresponding to different knowledge-based CAD is easy. Therefore, designing of similar components with different knowledge-based CAD becomes easier.

Preferably, the step of preparing the intermediate knowledge code of the second aspect of the invention comprises the steps of conducting a morphological analysis or syntactic analysis for the description of the design document which is described in a natural language and preparing the intermediate knowledge code which matches morphological information and syntactic information in accordance with the intermediate knowledge code generating rules based upon the morphological information or syntactic information which is obtained by the morphological analysis or the syntactic analysis.

In accordance with this preferable process, comparison of the design document described in a natural language with accumulated intermediate knowledge code generating rules and evaluation of the design document can be appropriately conducted, so that the intermediate knowledge code generating rules can be sufficiently utilized. Therefore, preparation of the intermediate knowledge code can be quickly and appropriately conducted.

More preferably, at the step of converting the intermediate knowledge code into the knowledge code in accordance with the knowledge code generating rules in the second aspect, the knowledge code is a CAD codes used for the knowledge-based CAD, and in order to convert the intermediate presentation code into the CAD code used for a plurality of different knowledge-based CADs, the intermediate knowledge code is converted into a plurality of different CAD codes in accordance with a plurality of different knowledge-based code generating rules.

In accordance with this more preferable process, conversion of the intermediate knowledge codes into the plurality of CAD codes used for different knowledge-based CADs can be quickly and easily conducted.

And more preferably, after the step of converting the intermediate knowledge code into the knowledge code in accordance with the knowledge code generating rules in the second aspect, the knowledge code is reconverted into the intermediate knowledge code by using a knowledge code compiler and further the intermediate knowledge code is converted into different knowledge codes by using different knowledge code generating rules.

In accordance with this more preferable process, mutual exchange of knowledge codes among different knowledge-based systems is easy.

According to a third aspect of the invention, the system for generating a knowledge code used for a knowledge-based system, comprises a knowledge code generator for converting a text which is described in a natural language into a knowledge code and knowledge code input means for inputting the knowledge code to the knowledge-based system. The knowledge code generator includes an intermediate knowledge code generating unit for generating an intermediate knowledge code which represents the knowledge of an object field and does not depend on the knowledge-based system, from the description of the text which is described in a natural language in accordance with intermediate knowledge code generating rules and a knowledge code converting unit for converting the intermediate knowledge code into a knowledge code which can be used in the knowledge-based system in accordance with knowledge code generating rules.

In accordance with the third aspect of the invention, conversion of the text into the intermediate knowledge code and conversion of the intermediate knowledge code into the knowledge code can be semi-automatically conducted. Conversion can be also conducted by a common device in even different knowledge-based system.

Preferably, the knowledge code generator in the system of the third aspect comprises an intermediate knowledge code generating unit for generating an intermediate knowledge code which represents the knowledge of design object field and does not depend on the knowledge-based CAD, from the description of the design document which is described in a natural language in accordance with the intermediate knowledge code generating rules and a knowledge code converting unit for converting the intermediate knowledge code into the knowledge code in accordance with the knowledge code generating rules of the knowledge-based CAD.

In accordance with this system, conversion of the design document into the intermediate knowledge code and conversion of the intermediate knowledge code into the knowledge code can be semi-automatically conducted. Since the design document is converted into the intermediate knowledge code and the intermediate knowledge code is converted into the knowledge code, conversion of the design document into the intermediate knowledge code can be conducted by a common device in even different knowledge-based CAD.

More preferably, the intermediate knowledge code generating unit in the third aspect conducts a morphological analysis or syntactic analysis for the description of the design document which is described in a natural language and generates an intermediate knowledge code which matches morphologic information or syntactic information in accordance with the intermediate knowledge code generating rules based upon the morphological information or syntactic information which is obtained by the morphological analysis or the syntactic analysis.

In accordance with this system, comparison of the design document described in a natural language with the accumulated intermediate knowledge code generating rules and evaluation of the design document can be appropriately conducted, so that the intermediate knowledge code generating rules can be sufficiently utilized. Therefore, preparation of the intermediate knowledge code can be quickly and appropriately conducted.

And more preferably, for converting the intermediate knowledge code into a plurality of different CAD codes in accordance with a plurality of different knowledge code generating rules in the system of the third aspect, in the knowledge code converting unit, the intermediate knowledge code is converted into the CAD code used for a plurality of different knowledge-based CADs.

In accordance with this system, since the intermediate knowledge code is converted into a plurality of different CAD codes in accordance with a plurality of different knowledge code generating rules, similar design can be easily conducted by using different knowledge-based CAD.

And more preferably, in the third aspect, the knowledge code generator reconverts the knowledge code into the intermediate knowledge code by using a knowledge code compiler after conversion of the intermediate knowledge code into the knowledge code in accordance with the knowledge code generating rule and converts the intermediate knowledge code into different knowledge code in accordance with the knowledge code generating rule.

In accordance with this system, the intermediate knowledge code can be converted into a plurality of different knowledge codes.

According to a fourth aspect of the invention, the process for producing a knowledge code which is used in a knowledge-based system is characterized in that said process comprises the steps of preparing a text which is described in a natural language by means of a text description assistant system, converting the text into an intermediate knowledge code, converting the intermediate knowledge code into a knowledge code, and inputting the knowledge code into the knowledge-based system, and the text describing assistant system is adapted to prepare the text by inputting describing items in accordance with a preliminarily provided text description procedure. The step of converting the text into the intermediate knowledge code converts the description of a formal text into the intermediate knowledge code which corresponds to the formal text and does not depend upon the knowledge-based system. The step of converting the intermediate knowledge code into the knowledge code converts the intermediate knowledge code into the knowledge code which can be used in the knowledge-based system in accordance with knowledge code generating rules.

In accordance with this process, the text is prepared by using the text describing assistant system. Therefore, the text can be prepared easily by even unskilled persons and the description of the text is uniformed and has no omission of words in comparison with a text which is freely described by a text editor. Since the description of the text is uniformed, correspondence between the text and the intermediate knowledge code can be preliminarily determined and conversion of the intermediate knowledge code is smooth and reliable. Since the knowledge code is prepared via the intermediate knowledge code, the text described in a natural language can be smoothly converted into the knowledge code irrespective of the knowledge-base system. Conversion of the knowledge code into other knowledge code corresponding to different knowledge-based system becomes easier.

According to a fifth aspect of the invention, the process for converting a knowledge code used in a knowledge-based system into a text which is described in a natural language is characterized in that the knowledge code is output from the knowledge-based system, the output knowledge code is converted into the intermediate knowledge code which does not depend upon the knowledge-based system by using an intermediate knowledge code converting unit and the intermediate knowledge code is converted into the text corresponding to the intermediate knowledge code by using a document description generating unit.

In accordance with this process, the content of the knowledge code can be confirmed with the text described in a natural language. Confirmation and verification of the input design knowledge, and update and retrieval of the design knowledge can be conducted for check and maintenance of the design rules and the design procedure. The design information can be shared by storing it in a database as a design standard.

Preferably, in the fourth aspect of the invention, at the steps of preparing a text which describes the knowledge of an object field in a natural language by using the text description assistant system and converting the text into the intermediate knowledge code, the process further includes the step of preparing an intermediate knowledge code which does not depend upon the knowledge base system, from the description of the text which is described in a natural language and is prepared without using the text description assistant system in accordance with intermediate knowledge code generating rules.

In accordance with this preferable process, an intermediate knowledge code for a text having a representation unlisted in the text describing assistance system can be prepared and the text which is described in a natural language other than a text prepared by the text describing assistance system can be converted into the knowledge code.

According to a sixth aspect of the invention, the process for generating a CAD knowledge code used in a knowledge-based CAD is characterized in that the process comprises the step of preparing a design procedure document which is described in a natural language by a design procedure document description assistance system, converting the design procedure document into an intermediate knowledge code, converting the intermediating code into a CAD knowledge code and inputting the CAD knowledge code into the knowledge-based CAD.

The design procedure document description assistance system is adapted to describe the design procedure document by selecting and inputting description items of the design procedure document in accordance with preliminarily provided description rules.

The step of converting the design procedure document into the representation code converts the description of the design procedure document into the intermediate knowledge code corresponding to the description of the design procedure document and does not depend upon the knowledge-based CAD.

The step of converting the intermediate knowledge code into the knowledge code converts the intermediate knowledge code into the CAD knowledge code which can be used in the knowledge-based CAD in accordance with knowledge code generating rules.

In accordance with the sixth aspect of the invention, since the design procedure document is prepared by using the design procedure document description assistance system, the design procedure document can be easily prepared even by unskilled persons. In comparison with the design procedure document which is freely described by designers, the description of the design procedure document is uniformed and the items which are necessary for the design are positively described and omission thereof is prevented. Since the description of the design procedure document is uniformed, correspondence between the design procedure document and the intermediate knowledge code can be preliminarily determined and conversion of the design procedure document into the intermediate knowledge code is smooth and positive. Since the CAD knowledge code is generated via the intermediate knowledge code, the design procedure document described in a natural language can be smoothly converted into CAD knowledge codes corresponding to a plurality of CAD systems irrespective of the knowledge-based CAD. Furthermore, conversion of the CAD knowledge code into another CAD knowledge code corresponding to different knowledge-based CAD becomes easier.

Preferably, the design procedure document description assistance system in the sixth aspect selects formal texts which constitute preliminarily provided design procedure document. A number of formal texts are preliminarily classified and prepared so that the design procedure document can be prepared by sequentially selecting the description procedure of the formal texts and each formal text of the design procedure document corresponds to the intermediate knowledge code.

In accordance with this preferable process, the design procedure document can be prepared by selecting formal texts constituting the description procedure of the preliminarily provided design procedure document and sequentially selecting the description procedure of the formal texts. The design procedure document can be appropriately prepared even by unskilled designers without causing any omission of words. Since the description of the design procedure document is preliminarily caused to correspond to the intermediate knowledge code, conversion of the design procedure document into the intermediate knowledge code can be smoothly and positively conducted.

According to a seventh aspect of the invention, the process for converting a CAD knowledge code used in a CAD knowledge-based system into a design procedure document which is described in a natural language is characterized in that the CAD knowledge code is output from the knowledge-based CAD system, the output CAD knowledge code is converted into the intermediate knowledge code which does not depend upon the knowledge-based system by using an intermediate knowledge code converting unit, and the intermediate knowledge code is converted into the design procedure document comprising formal texts corresponding to the intermediate knowledge code by using a document description generating unit.

In accordance with the seventh aspect of the invention, the content of the CAD knowledge code can be confirmed with the design procedure document described in a natural language, so that the content of an original design procedure document can be confirmed and verification of modeling can be conducted. In case of update of the design procedure document, the design procedure document can be conveniently revised while confirming the original design procedure document. Furthermore, since the CAD knowledge code can be quickly converted into the design procedure document which is described in a natural language, the design procedure document can be readily and conveniently understood when it is utilized as design information by a third party or when unskilled designers are educated.

Preferably, in the sixth aspect of the invention, at the steps of preparing the design procedure document which describes the knowledge of an object field in a natural language by using the design procedure document description assistance system, and converting the design procedure document into the intermediate knowledge code, the process further comprises the step of conducting a morphological analysis or syntactic analysis of the description of the design procedure document which is prepared without using the design procedure document description assistance system and is described in a natural language and preparing the intermediate knowledge code which does not depend on the knowledge-based CAD in accordance with the intermediate knowledge code generating rules based upon morphological information or syntactic information which is obtained by the morphological analysis or syntactic analysis.

In accordance with this process, the intermediate knowledge code can be prepared for the design procedure document having a representation unlisted in the design procedure document description assistance system of a special design procedure or new design procedure. Any design procedure document can be converted into the CAD knowledge code.

More preferably, in the process for generating CAD knowledge codes in the sixth aspect, in order to convert the intermediate knowledge code into the CAD knowledge codes used for a plurality of different the knowledge-based CADs, the intermediate knowledge code is converted into the plurality of different the CAD knowledge codes in accordance with a plurality of different knowledge code generating rules.

In accordance with this process, respective knowledge code generating rules can be utilized when the intermediate knowledge code is converted into the plurality of different CAD knowledge codes in accordance with the plurality of knowledge code generating rules. Therefore, the intermediate knowledge code can be quickly and easily converted into the plurality of CAD knowledge codes used for different knowledge based CADs.

According to an eighth aspect of the invention, the knowledge code generating system for generating a knowledge codes used in a knowledge-based system is characterized in that the knowledge code generating system comprises a text generating unit for preparing a text which is described in a natural language by means of a text description assistance system, an intermediate knowledge code generating unit for converting the text into an intermediate knowledge code, a knowledge code converting unit for converting the intermediate code into a knowledge code and a knowledge code input unit for inputting the knowledge code into the knowledge-based system.

The text generating unit is adapted to describe the text by using a text preparing tool which prepares a text using formal texts by inputting description items in accordance with preliminarily provided text description procedure.

The intermediate code converting unit is adapted to convert the description of the formal text of the text into the intermediate knowledge code which corresponds to the formal text and does not depend on the knowledge-based system, and the knowledge code converting unit is adapted to convert the intermediate knowledge code into the knowledge code which can be used in the knowledge-based system by using a knowledge code generating rules.

Since the system of the eighth aspect of the invention includes the text generating unit for preparing a text which is described in a natural language by means of the text description assistance system, the text can be easily prepared even by unskilled persons and the description of the text which is prepared by the text generating unit is uniformed and has no omission of words is caused in comparison with the text which is freely described by a text editor. Since the description of the text is uniformed, correspondence between the text and the intermediate knowledge code can be preliminarily determined in the intermediate knowledge code converting unit for converting the text into the intermediate knowledge code and the conversion of the text into the intermediate knowledge code is smooth and positive. Since the knowledge code converting unit generates the knowledge code via the intermediate knowledge code, it is capable of smoothly converting the text which is described in a natural language into the knowledge code irrespective of the knowledge-based system.

Conversion of the knowledge code into another knowledge code corresponding to different knowledge-based system becomes easier.

According to a ninth aspect of the invention, the knowledge code converting system for converting a knowledge code used in a knowledge-based system into a text which is described in a natural language is characterized in that the knowledge code converting system comprises a knowledge code output unit for outputting the knowledge code from the knowledge-based system, an intermediate knowledge code converting unit for converting the output knowledge code into an intermediate knowledge code which does not depend on the knowledge-based system and a document description generating unit for converting the intermediate knowledge code into a text including the intermediate knowledge code and corresponding formal texts, which is described in a natural language.

In accordance with the ninth aspect of the invention, the content of the knowledge code can be confirmed based on the text described in a natural language and the content of the original text can be verified. Update and revision of the content of the text can be conducted, so that the text can be widely and conveniently used as information.

Preferably, in the sixth aspect of the invention, the knowledge code generating system for generating a knowledge code used in the knowledge-based system further comprises a unit for preparing an intermediate knowledge code which represents the knowledge of an object field and does not depend upon the knowledge-based system from the description of a text which is prepared without using the text description assistance system and is described in a natural language in accordance with an intermediate knowledge code generating rules in addition to the text generating unit for preparing the text which is described in a natural language by the text description assistance system and the intermediate knowledge code generating unit for converting the text into the intermediate knowledge code.

In accordance with this system, it is possible to prepare the intermediate knowledge code for a text having a representation which unlisted in the text describing assistance system and it is possible to convert the text which is described in a natural language and is not prepared by the text description assistance system into the knowledge code.

According to a tenth aspect of the invention, the knowledge generating system which is used in a knowledge-based CAD, comprises a design procedure document generating unit for preparing a design procedure document which is described in a natural language by a design procedure document description assistance system, and an intermediate knowledge code generating unit for converting the design procedure document into an intermediate knowledge code, a CAD code converting unit for converting the intermediate knowledge code into a CAD knowledge code and a knowledge code input unit for inputting the CAD knowledge code into the knowledge-based CAD.

The design procedure document generating unit is adapted to describe the design procedure document by using a design procedure document preparing tool for preparing a design procedure document by inputting design items in accordance with preliminarily provided description rules of the design procedure document.

The intermediate knowledge code generating unit is adapted to convert the description of the design procedure document into the intermediate knowledge code which corresponds to the description of the design procedure document and does not depend on the knowledge-based CAD, and the CAD code converting unit is adapted to convert the intermediate knowledge code into the knowledge code which can be used in the knowledge-based CAD by using a knowledge code generating rules.

Since the system of the tenth aspect of the invention is provided with the design procedure document generating unit for preparing a design procedure document by using a design procedure document description assistance system, the design procedure document can be easily prepared even by unskilled persons, and in comparison with the design procedure document which is freely described by designers, the description of the design procedure document is uniformed and the items which are necessary for design are positively described and no omission of words is caused. Since the description of the design procedure document is uniformed, information on the correspondence between the design procedure document and the intermediate knowledge code can be preliminarily input to the intermediate knowledge code converting unit and conversion of the intermediate knowledge code is smooth and positive. Since there is provided the knowledge code converting unit for converting the intermediate knowledge code into the CAD knowledge code, the design procedure document which is described in a natural language can be smoothly converted into a CAD knowledge codes corresponding to a plurality of CAD systems irrespective of the knowledge-based CAD. Conversion of the CAD knowledge code into the CAD knowledge code corresponding to different knowledge-based CAD also becomes easier.

Preferably, in the knowledge code generating system for generating a knowledge code of the tenth aspect of the invention, the design procedure document generating unit selects formal texts which constitute preliminarily provided design procedure document, and a number of the formal texts are preliminarily classified and prepared so that the design procedure document can be prepared by sequentially selecting the description procedure of the formal texts and each description item of the design procedure document corresponds to the intermediate knowledge code.

In accordance with this preferable system, the design procedure document can be prepared by the design procedure document generating unit sequentially selecting candidates in which the format texts are described. The design procedure document can be appropriately prepared even by unskilled designers without causing any omission of words. Since the description of the design procedure document is preliminarily caused to correspond to the intermediate knowledge code, conversion of the design procedure document into the intermediate knowledge code can be smoothly and positively conducted.

According to an eleventh aspect of the invention, the system for converting a CAD knowledge code used in a knowledge-based CAD into a design procedure document which is described in a natural language is characterized in that the system comprises an intermediate knowledge code converting unit for outputting the knowledge CAD code from the knowledge-based CAD to convert the CAD knowledge code into the intermediate knowledge code which does not depend on the knowledge-based CAD, and a document description generating unit for converting the intermediate knowledge code into the design procedure document including the intermediate knowledge code and corresponding formal text.

In accordance with the eleventh aspect of the invention, the content of the CAD knowledge code can be confirmed based on the design procedure document described in a natural language, the content of the original design procedure document can be confirmed and the prepared CAD modeling can be verified. In case of update of the document procedure document, the design procedure document can conveniently be revised while confirming the original design procedure document since the CAD knowledge code can be quickly converted into the design procedure document which is described in a natural language, the design procedure document can be easily and conveniently understood when it is utilized as design information by third party or when unskilled designers are educated.

Preferably, in the system of the tenth aspect of the invention, in the system for generating a knowledge code in which in addition to the design procedure document preparing unit for preparing the design procedure document which is described in a natural language and the intermediate knowledge code generating unit for converting the design procedure document into the intermediate knowledge code, the system further comprises a unit for conducting a morphological analysis or syntactic analysis of the description of the design procedure document which is prepared without using the design procedure document description assistance system and is described in a natural language and for preparing the intermediate knowledge code which does not depend on the knowledge-based CAD in accordance with the intermediate knowledge code generating rules based upon morphological information or syntactic information which is obtained by the morphological analysis or syntactic analysis.

In accordance with this preferable system, the intermediate knowledge code can be prepared for the design procedure document having a representation unlisted in the design procedure document description assistance system of a special design procedure or new design procedure. Various design procedure documents can be converted into the CAD knowledge code.

Other objects, features, and characteristics of the present invention will become apparent upon consideration of the following description and the appended claims with reference to the accompanying drawings, all of which form a part of this specification.

### BRIEF DESCRIPTION OF THE DRAWINGS

FIG. 1 is a flow chart showing a flow of information on prior art product design;

FIG. 2 is a flow chart showing a flow of information on the product design using a prior art knowledge-based CAD;

FIG. 3 is a flow chart showing the basic flow for converting a text described in a natural language into a knowledge code and for reconverting the knowledge code into the text in accordance with the present invention;

FIG. 4 is a diagram showing the basic configuration of a system which prepares a component production procedure document and generates a CAD knowledge code from the component production procedure document and reconverts the CAD knowledge code into the component production procedure document in accordance with the present invention;

FIG. 5 is a flow chart showing a process for generating an intermediate knowledge code of the present invention;

FIG. 6 is a diagram showing a detailed example for generating the intermediate knowledge code of the present invention;

FIG. 7 is a flow chart showing a process for generating the intermediate knowledge code of the present invention;

FIG. 8 is a diagram showing a detailed example for generating the intermediate knowledge code of the present invention;

FIG. 9 is a flow chart showing a process for generating a CAD knowledge code of the present invention;

FIG. 10 is a diagram showing a detailed example for generating the CAD knowledge code of the present invention;

FIG. 11 is a flow chart showing a process for converting the CAD knowledge code into the intermediate knowledge code in accordance with the present invention;

FIG. 12 is a diagram showing a detailed example for converting the CAD knowledge code into the intermediate knowledge code in accordance with the present invention;

FIG. 13 is a flow chart showing a process for converting the intermediate knowledge code into the component production procedure document in accordance with the present invention;

FIG. 14 is a diagram showing a detailed example for converting the intermediate knowledge code into the component production procedure document in accordance with the present invention; and

FIG. 15 is a flow chart showing a method of using the knowledge-based CAD of the present invention.

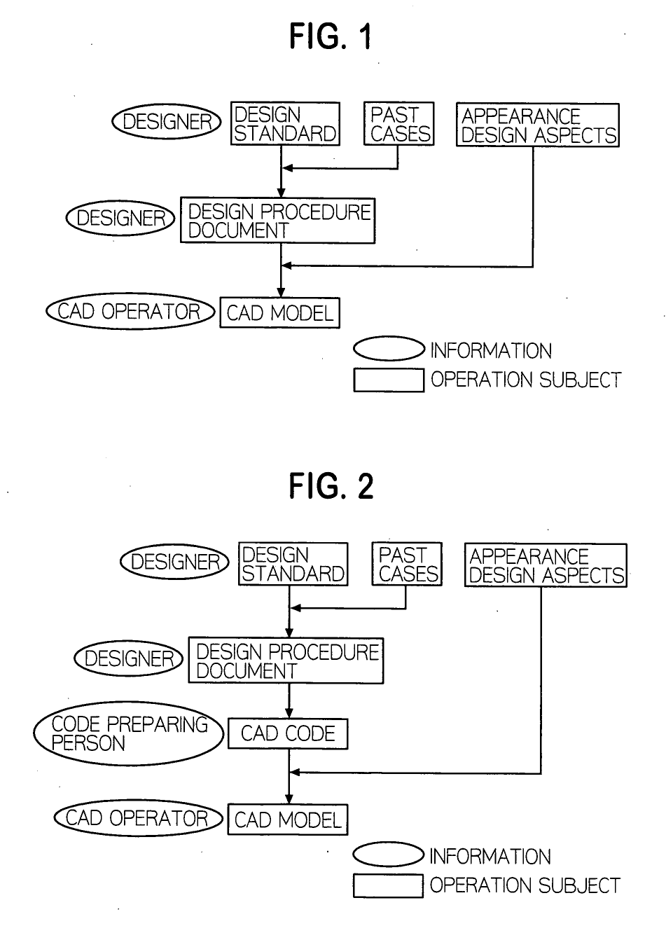

### DETAILED DESCRIPTION OF THE PREFERRED EMBODIMENTS

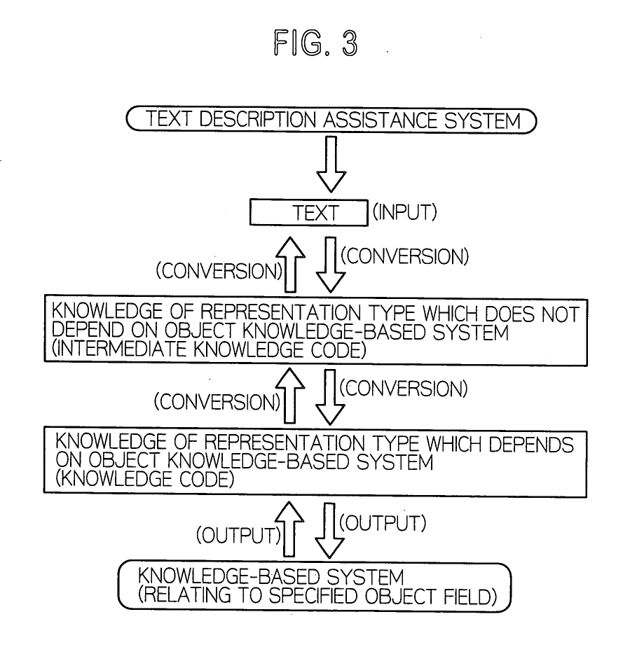

Modes of embodying the invention will be described with reference to drawings. FIG. 3 is a flow chart showing the basic flow of a process comprising the steps of preparing a text which is described in a natural language by means of a text describing assistant system, converting the text into a knowledge code used in a knowledge-based system via intermediate knowledge code and reconverting the knowledge code into the text which is described in a natural via the intermediate knowledge codes.

A text is uniformly prepared with formal wording by using a text describing assistant system and is converted into an intermediate knowledge code having a representation format which does not depend upon any knowledge-based system to be used which is related with a specified object field, that is which can be used commonly among various knowledge-based systems. Subsequently, the intermediate knowledge code is converted into knowledge codes in accordance with knowledge code generating rules corresponding to respective knowledge based system. Then, the converted knowledge code is output to respective knowledge-based system. Then, the knowledge code input to the knowledge-based system is reconverted into a text of the natural language so that it is confirmed, updated and used is a information data base.

Alternatively, the text which is described in a natural language is converted into an intermediate code of a representation format which does not depend upon used knowledge base system related with a specified object field, which can be widely used commonly among knowledge-based systems.

Although the present invention is applicable to various knowledge-based systems as mentioned above, the present invention is not limited to this, but also is widely applicable to other systems such as automobile fault diagnosis expert systems, legal case retrieval systems and medical diagnosis systems.

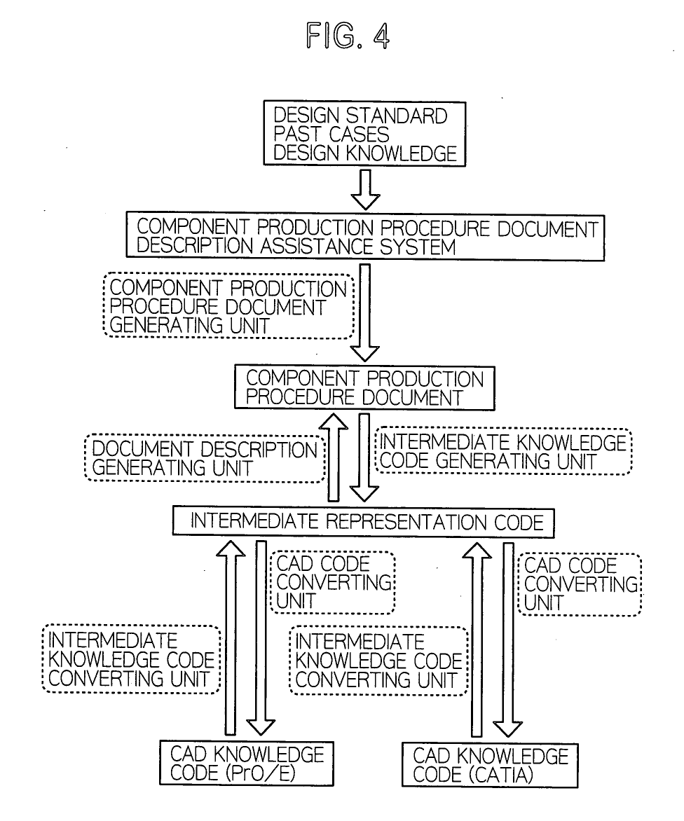

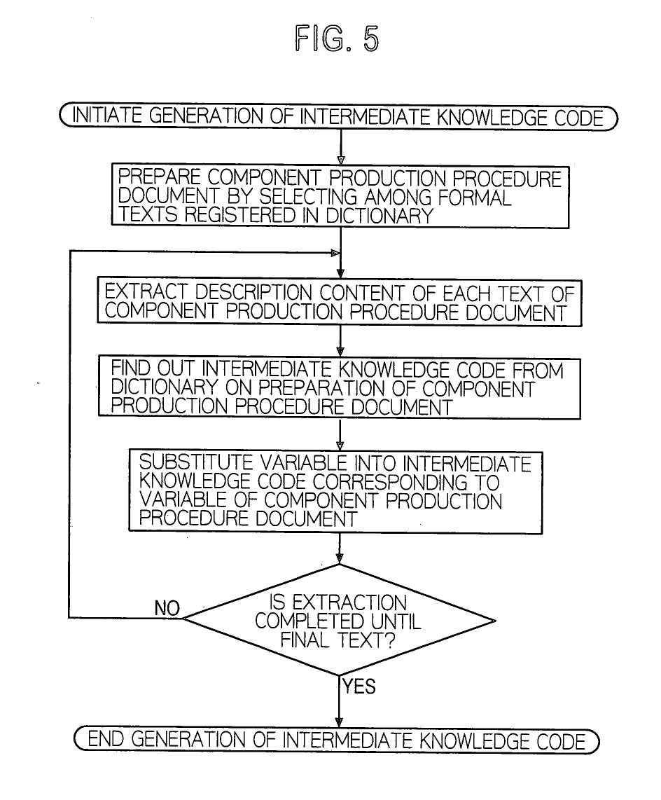

Now, a mode of embodying the present invention will be described by way of design of a component with reference to FIGS. 4 to 15. FIG. 4 shows the procedure for designing a component by using a knowledge-based CAD. On designing a component, a design standard which specifies the requirement for the component and an appearance or ornamental aspect of the design which specifies the appearance design requirements is determined at the initial stage of the design. In response to the requirements, a component production procedure document 12 describing the dimensions and shape of the component and a process for determining the same is prepared based upon designer's knowledge, know-how and experiences with reference to past design drawings of similar component.

Preparation of this component production procedure document 12 is conducted by using a component production procedure document describing assistance system 10. This component production procedure document describing assistance system 10 accumulates each element of a number of describing features which are preliminarily described in the component production procedure document 12 as formal texts. The formal texts are classified so that they can be easily used when the component production procedure document 12 is prepared.

The component production procedure document 12 is prepared by selecting among candidates of the formal texts in order on the screen of a device on which the system of CAD and the like is installed and entering necessary items in accordance with instructions from the system. Therefore, the component production procedure document 12 is described with uniformed texts having no omitted wording. The design document is not limited to the component production procedure document 12, but may be documents in which wide knowledge on designs is described in a natural language.

If the component production procedure document 12 can not be necessarily described with only formal texts, texts other than formal texts in which omitted words are described in a natural language may be added. In this case, described contents of each text of the component production procedure document 12 which is described in texts of natural language other than the formal text are extracted. Thereafter, the sentences of the component production procedure document 12 of natural language are morphologically analyzed. The morphologically analyzed sentences are parsed or syntactically analyzed. Morphological analysis and syntactic analysis may be separately conducted or both may be simultaneously conducted. They can be appropriately conducted depending upon the content of the natural language.

Then information on the morphologic analysis and syntactic analysis is compared with the intermediate knowledge code generation rules in which syntax information is preliminarily accumulated for evaluation. Intermediate knowledge code generation rules which match the morphological information and syntactic information is selected for generating intermediate knowledge codes. If the syntax of the sentences of the component production procedure document 12 is not relevant to the intermediate knowledge codes at this time, modification of the description of the component production procedure document 12 is conducted. The intermediate knowledge codes are generated by conducting any one or both of the morphological analysis and syntactic analysis for the component production procedure document 12 in such a manner that the entire of the component production procedure document 12 is converted into intermediate knowledge codes. This conversion is repeated for generating the intermediate knowledge codes until final text is converted.

The summary of the flow of the process of the generation and utilization of the CAD knowledge code in case in which CATIA, one of knowledge-based CAD is used will be described with reference to FIG. 4. Firstly, a component production procedure document 12 is prepared by using a component production procedure document description assistant system 10. Then the process for converting the component production procedure document 10 into CAD knowledge codes (knowledge codes) of various different knowledge-based CADs comprises the steps of generating an intermediate code; generating a CAD knowledge code; reconverting the CAD knowledge code and reconverting the intermediate knowledge code 22 into the component production procedure document 12.

When the component production procedure document 12 is prepared by using the component production procedure document description assistance system 10, the component production procedure document 12 is input to an intermediate knowledge code generating unit 20 by the component production procedure document description assistance system 10. For conversion from the component production procedure document 12 to the intermediate knowledge code 22, it may be conducted after full component production procedure document 12 has been prepared, or it may be conduced for each sentence of the component production procedure document 12. The description content of the component production procedure document 10 is converted into an intermediate knowledge code in an intermediate knowledge code generating unit 20. Then, the intermediate knowledge code is converted into a CAD knowledge code used in CATIA by using a CAD code converting unit 30 which will be described hereafter.

In such a manner, the component production procedure document 12 is converted into the CAD knowledge code so that it can be used in CATIA. If the CAD knowledge code is used for knowledge-based CADs other than CATIA, the CAD knowledge code converted for CATIA is reconverted into an intermediate knowledge code by using an intermediate knowledge code converting unit 40 which will be described below. The reconverted intermediate knowledge code is converted into a CAD knowledge code for, for example, Pro/E, a different knowledge-based CAD by using a CAD code converting unit 35 for Pro/E.

Now, the system configuration ranging from the component production procedure document description assistance system 10 to the CAD knowledge code generating unit will be described with reference to FIG. 4. As mentioned above, the component production procedure document 10 is prepared in a natural language by the component production procedure document description assistance system 10. Since the component production procedure document assistance system 10 accumulates each element of a number of description features which are preliminarily written in the component production procedure document 12 as a dictionary of formal texts as mentioned above. A menu for selecting among formal texts is displayed, so that the formal texts can be selected. If variables are entered by sequentially selecting the menu, the component production procedure document 12 would be prepared.

It is the intermediate knowledge code generating unit 20 that converts the component production procedure document 10. The intermediate knowledge code generating unit 20 may be a computer on which an intermediate knowledge code generating software is installed independently of the knowledge-based CAD, or the intermediate knowledge code generating software is installed in addition to the knowledge-based CAD. CAD code converting units 30 and 35 are configured to generate CAD knowledge codes for respective knowledge-based CADs. The CAD code generating units 30 and 35 may be computers on which CAD knowledge code generating software are installed independently of the knowledge-based CAD, or alternatively CAD knowledge code generating software are installed in addition to the knowledge-based CADs similarly to the intermediate knowledge code generating unit 20.

Intermediate knowledge code converting units 40 and 45 are used when the CAD knowledge codes are converted into those for different knowledge-based CAD. The CAD knowledge code is reconverted into intermediate presentation code by respective intermediate knowledge code converting unit 40. Then, the reconverted intermediate knowledge code is converted into CAD knowledge code by the CAD converting unit 35 for the knowledge-based CAD. Although the intermediate knowledge code converting unit 40 has been described, reconversion of the knowledge code into the intermediate knowledge code can be carried out by using a knowledge code compiler other than CAD.

Steps of preparing the component production procedure document 12 and preparing the intermediate knowledge code are shown in FIG. 5. Preparation of the component production procedure document 12 relies upon the design procedure document description assistance system 10. The intermediate knowledge code generating unit 20 generates the intermediate knowledge code in accordance with the steps. Firstly, the component production procedure document 10 which is prepared in the component production procedure document generating unit 15 of the component production procedure document description assistance system 10 is input into the intermediate knowledge code generating unit 20 by the component production procedure document description assistance system 10. Then generation of the intermediate knowledge code is initiated. Description contents of each text of the component production procedure document 10 are extracted. Thereafter, the intermediate knowledge code 22 is retrieved from the dictionary of the component production procedure description assistance system 10 and a variable of the component production procedure document 12 is substituted into the intermediate knowledge code 22 corresponding thereto. This operation is repeated until final text, whereupon generation of the intermediate knowledge code 22 is completed. Since the description of respective formal text of the component production procedure document 12 is preliminarily caused to correspond to the intermediate knowledge code 22, conversion into the intermediate knowledge code 22 is easy.

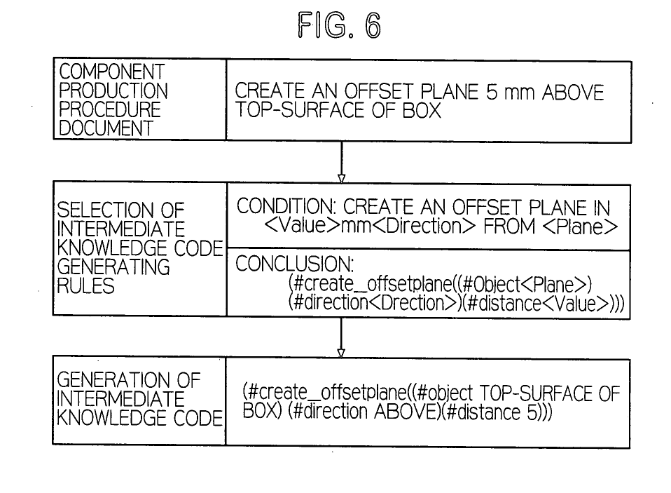

A detailed example of conversion of the component production procedure document 10 into the intermediate knowledge code is illustrated in FIG. 6. A sentence “create an offset plane 5 mm above top-surface of box” which is a text in the component production procedure document 10 which is input to the intermediate knowledge code generating unit 20 is selected as being relevant to the intermediate knowledge code generating rule which has been preliminarily accumulated as mentioned above. Results of selection are shown in the entry of “SELECTION OF INTERMEDIATE KNOWLEDGE CODE GENERATING RULES” in FIG. 6.

Since there are no description of “top surface of box”, “5 mm” which are specific variables in the selected intermediate knowledge code generating rule, the variables are entered for generating an intermediate knowledge code. The generated intermediate knowledge code is illustrated in the entry of “GENERATION OF INTERMEDIATE KNOWLEDGE CODE”. The intermediate knowledge code does not depend upon the kind of the knowledge-based CAD.

Then, conversion of a text written in a natural language into the intermediate knowledge code will be described.

As mentioned above, the intermediate knowledge code is described in a format which does not depend on the rule representation format of each knowledge-based CAD. The intermediate knowledge code defines frequently used operations in a general CAD operation, such as “prepare a straight line passing through two points” and “offset (move in parallel) a plane”.

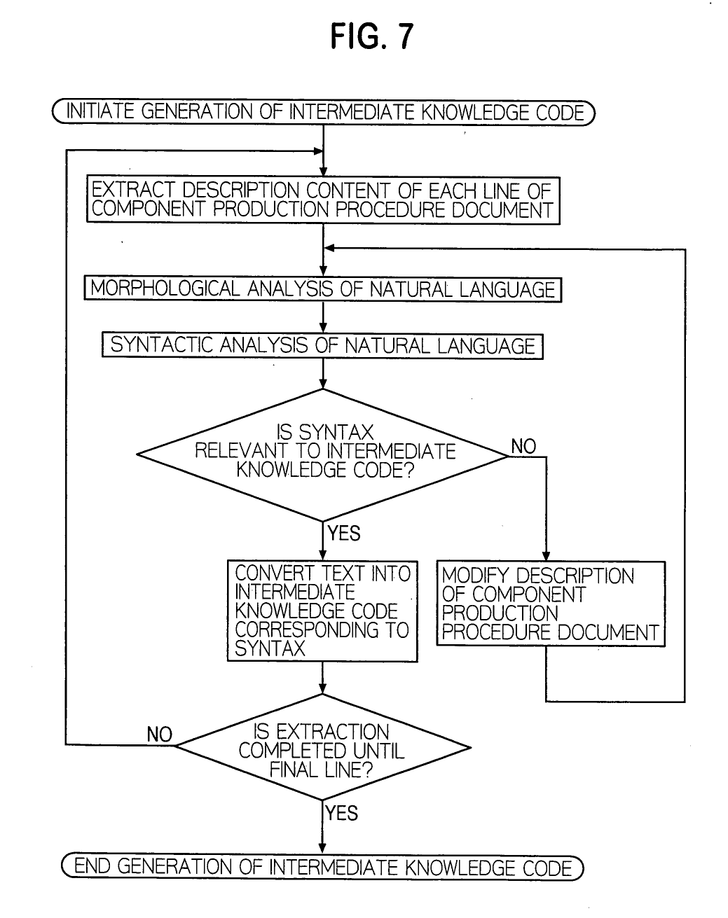

The steps for preparing the intermediate knowledge code are shown in FIG. 7. The intermediate knowledge code generating unit 20 generates the intermediate knowledge code in accordance with these steps.

The component production procedure document 10 written in a natural language is input to the intermediate knowledge code generating unit 20. Then generation of the intermediate knowledge code is initiated. Description contents of each text of the component production procedure document 10 are extracted. Thereafter, words in every line of the component production procedure document 12 of natural language is morphologically analyzed. The morphologically analyzed words are further syntactically analyzed. Any one of the morphological analysis and syntactic analysis may be separately conducted, or both of them may be simultaneously conducted. This may be appropriately selected depending upon the content of the natural language.

Then information on the morphological analysis and syntactic analysis is compared with the intermediate knowledge code generation rule in which syntax information is preliminarily accumulated for evaluation. Intermediate knowledge code generation rule which matches the morphological information and syntactic information is selected for generating intermediate knowledge codes. If the syntax of the sentences of the component production procedure document 12 is not relevant to the intermediate knowledge codes at this time, modification of the description of the component production procedure document 12 is conducted. The intermediate knowledge codes are generated by conducting any one or both of the morphological analysis and syntactic analysis for the component production procedure document 12 in such a manner that the entire of the component production procedure document 12 is converted into intermediate knowledge codes. This conversion is repeated for generating the intermediate knowledge codes until final text is converted.

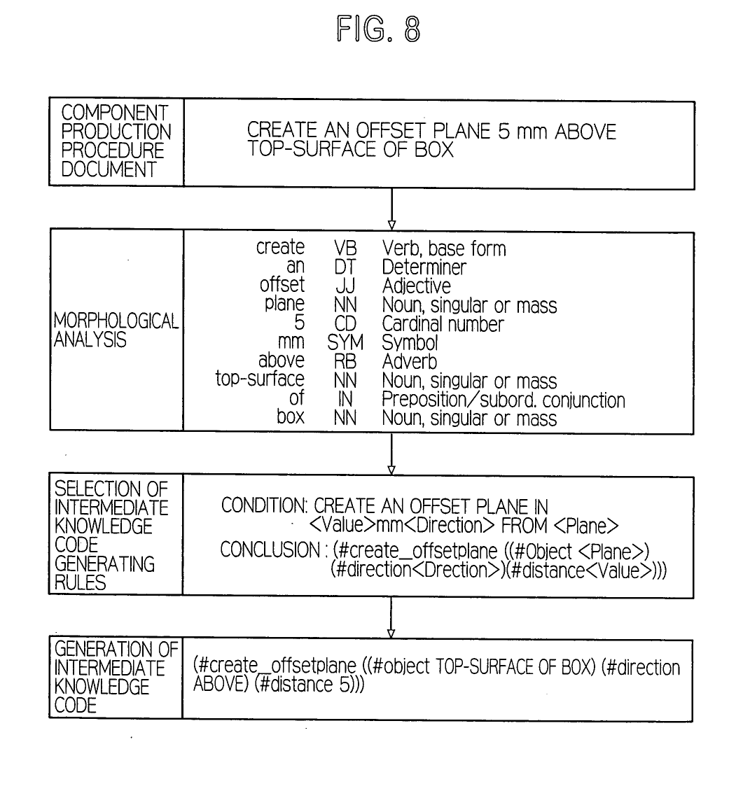

A detailed example of conversion of the component production procedure document 12 into the intermediate knowledge code is illustrated in FIG. 8. Morphological analysis of the words “Create an offset plane 5 mm above from top-surface of a box” provides result for each noun of the entry “MORPHOLOGICAL ANALYSIS”. In the morphological analysis in English, “Brill's Tagger (Natural Language Group at Microsoft Research)” was used as an analyzing tool.

In the morphological analysis in Japanese, “CHASEN version 2.1 (Matsumoto Laboratory, Daigakuin, Nara Sentan Kagakugijutsu Daigaku)” was used as an analyzing tool. By using the result of the morphological analysis, an intermediate knowledge code generation rule is selected which is most close in comparison with a number of intermediate knowledge code generation rules which are preliminarily accumulated as mentioned above. A result of the selection in English is shown in the entry of “selection of intermediate knowledge code generation rule” in FIG. 8. With respect to another language “selection of intermediate knowledge code generation rule” is available by using the morphological analysis tool in the same manner.

Since there are no description of “top of box”, “5 mm” which are specific variables in the selected intermediate knowledge code generating rule, the variables are entered for generating an intermediate knowledge code. The generated intermediate knowledge codes are illustrated in the entry of “GENERATION OF INTERMEDIATE KNOWLEDGE CODE”. The intermediate knowledge code does not depend upon the kind of the knowledge-based CAD.

Then, the intermediate knowledge code is converted to a CAD knowledge code which is used for the knowledge-based CAD by using the CAD code converting unit 30. The CAD code converting unit 30 is configured to convert the intermediate knowledge code into every CAD knowledge code of each knowledge-based CAD. The CAD knowledge code is prepared for each knowledge-based CAD. Although a mode of embodying the present invention will be described by using CATIA V5 as the knowledge-based CAD, the present invention is not limited to CATIA V5. If the CAD code converting unit 30 for respective knowledge-based CAD is used, the present invention is applicable to any knowledge-based CAD. The present invention is not limited to CAD, but is widely applicable in knowledge-based systems.

The CAD code converting unit 30 converts the intermediate knowledge code into the CAD knowledge code by using knowledge code generating rule. The knowledge code generating rule is kept in the CAD code converting unit and has the intermediate knowledge code and CAD knowledge code in a condition unit and conclusion unit, respectively. The CAD code converting unit 30 is capable of outputting codes which are converted into appropriate representations for every knowledge-based CAD by managing different variable names or each CAD knowledge code to be generated and positional relationship among objects.

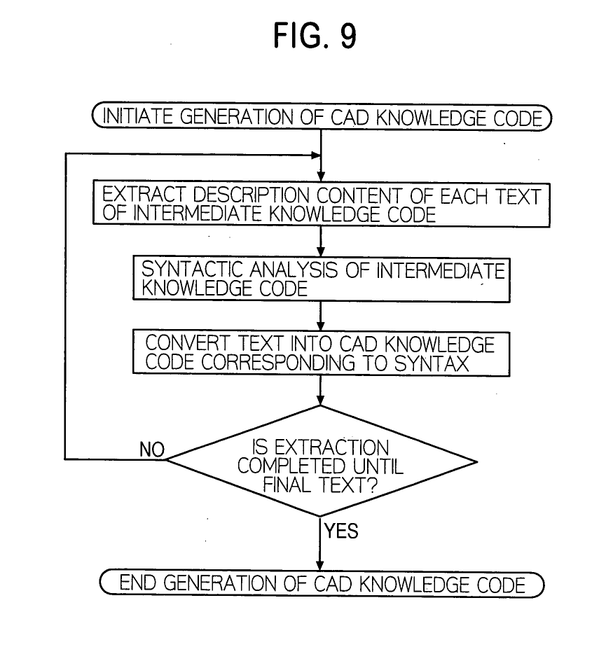

FIG. 9 shows a process for converting the intermediate knowledge code into the CAD knowledge code. The intermediate knowledge code which is generated in the intermediate knowledge code generating unit 20 is input to the CAD code converting unit 30. Then, generation of the CAD knowledge code is initiated. Description content of each line of the intermediate knowledge code is extracted for every sentence, so that syntactic analysis of the intermediate knowledge code is conducted. The intermediate knowledge code is converted into corresponding CAD knowledge code by comparing it with the knowledge code generating rule of the CAD code converting unit 30. The intermediate knowledge code is extracted and is converted into the CAD knowledge code by repeating this operation until the final text.

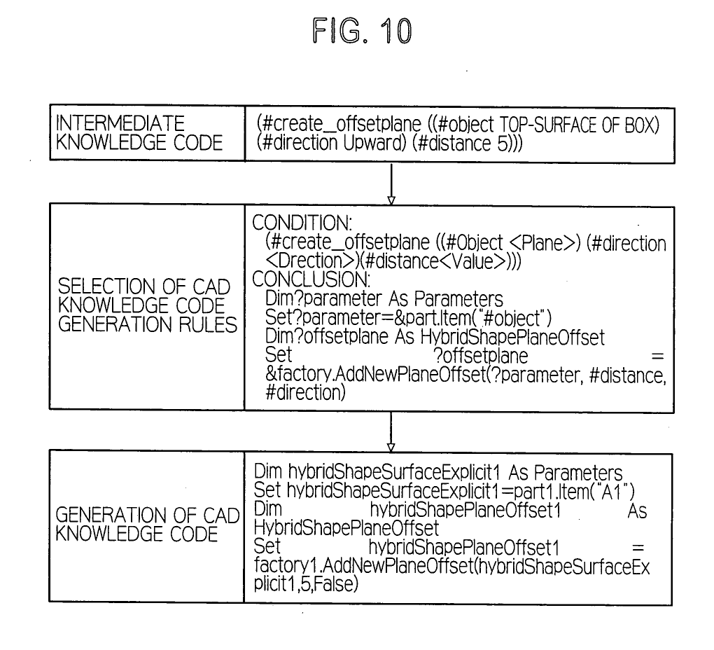

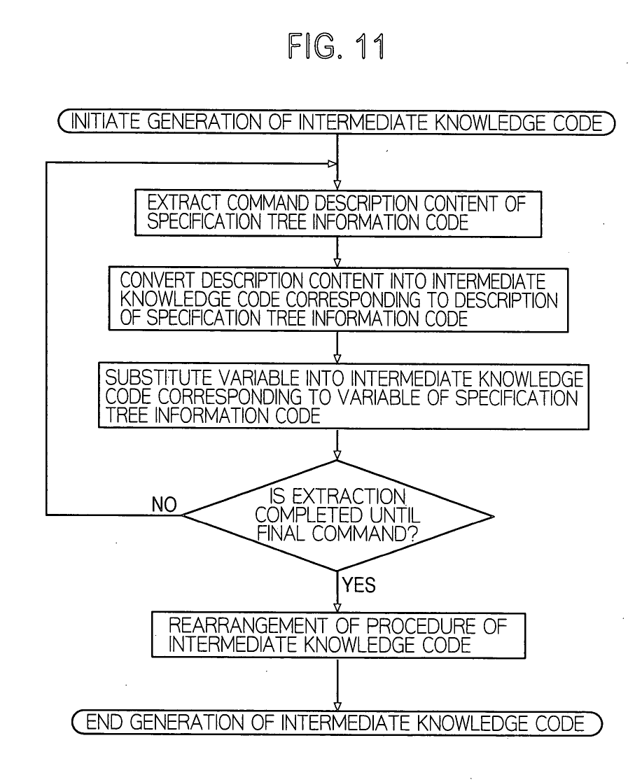

A detailed example of converting the intermediate knowledge code into the CAD knowledge code is illustrated in FIG. 10. The intermediate knowledge code which was converted from the component production procedure document 10 as mentioned above is described in the entry of “intermediate knowledge code” in FIG. 10, and is input to the CAD code converting unit 30. This input is automatically conducted by connecting the intermediate knowledge code generating unit 20 with the CAD code converting unit 30. The intermediate knowledge code generating unit 20 may be formed integrally with the CAD code converting unit 30, or alternatively may be formed separately therefrom so that they may be separated from each other.

Since the knowledge code generating rule which the CAD code converting unit 30 has comprises the intermediate knowledge code on the condition unit and the CAD knowledge code on the conclusion unit as shown in the entry “selection of CAD knowledge code generating rule” of FIG. 10, the intermediate knowledge code which was input to the CAD code converting unit 30 is compared with the intermediate knowledge code on the condition unit, so that it is converted into the CAD knowledge code on the conclusion unit. A result of conversion into the CAD knowledge code is set forth in the entry “generation of CAD knowledge code”. In case of FIG. 10, the CAD knowledge code is generated by entering a specific variable into the CAD knowledge code on the conclusion unit of the knowledge code generating rule. Specifically “top-surface of box” and “top-surface” is converted into representations “A1” and “False” respectively, for generating CAD knowledge code.

If the CAD knowledge code is used for different knowledge-based CAD, the CAD knowledge code is reversely reconverted into the intermediate knowledge code by using an intermediate knowledge code converting unit 40 as shown in FIG. 4. The reconverted intermediate knowledge code is converted to CAD knowledge code by using the CAD code converting unit 35 for different knowledge-based CAD.

Now, a process for converting the CAD knowledge code into the component production procedure document 12 via the intermediate knowledge code 22 as shown in FIG. 4 will be described. The CAD knowledge code is output from the knowledge-based CAD. In this case, the output CAD knowledge code may not necessarily be identical with the above-mentioned input CAD knowledge code. The output CAD knowledge code is a specification tree information code and is converted into the intermediate knowledge code 22 by means of the intermediate knowledge code converting units 35, 45. Then, the intermediate knowledge code 22 is converted into the component production procedure document 12 by means of a document description generating unit 25. Therefore, the component production procedure document 12 which is input into the knowledge-based CAD as the CAD knowledge code can be output as being described in a natural language. Hence, confirmation and update of the component production procedure document 12 is easy, so that the component production procedure document 12 can be used by a third part and/or be understood by even unskilled designer and design information can be shared.

FIG. 11 shows a process for converting the CAD knowledge code into the intermediate knowledge code. The CAD knowledge code which is input to the knowledge-based CAD is output as a specification tree information code, and is converted into the intermediate knowledge code 22 by means of the intermediate knowledge code converting units 40, 45. The description content of each line of the specification tree information code is extracted for every text, so that analysis of the specification tree information code is conducted. The specification tree information code is compared with the knowledge code generation rules of the intermediate knowledge code converting units 40, 45 and is converted into corresponding intermediate knowledge code 22. The specification tree information code is extracted until the final line by repeating this process, so that the specification tree information code is converted into the intermediate knowledge code 22.

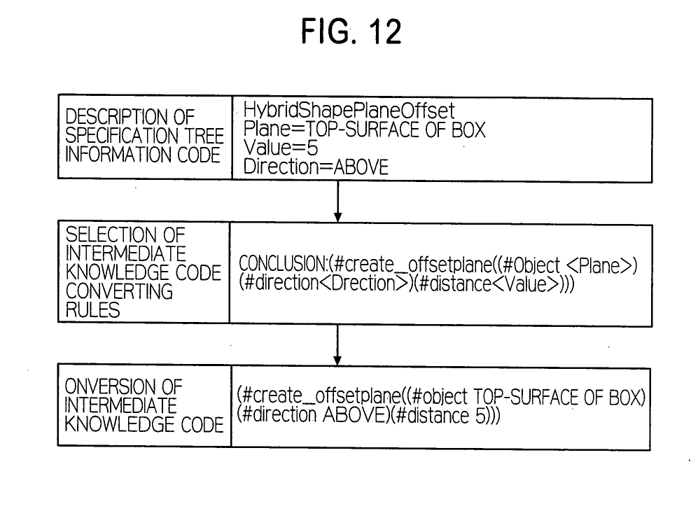

A detailed example of conversion of the specification tree information code into the intermediate knowledge code is shown in FIG. 12. A sentence “create an offset plane 5 mm above top-surface of box” which is one text in the specification tree information code input to the intermediate knowledge code converting units 40, 45 is selected as being relevant to the intermediate knowledge code generating rule which has been preliminarily accumulated as mentioned above. Results of selection are shown in the entry of “SELECTION OF INTERMEDIATE KNOWLEDGE CODE GENERATING RULES” in FIG. 12.

Since there are no description of “top surface of box”, “5 mm” which are specific variables in the selected intermediate knowledge code generating rule, the variables are entered for generating an intermediate knowledge code. The generated intermediate knowledge code is illustrated in the entry of “GENERATION OF INTERMEDIATE KNOWLEDGE CODE”. The intermediate knowledge code does not depend upon the kind of the knowledge-based CAD.

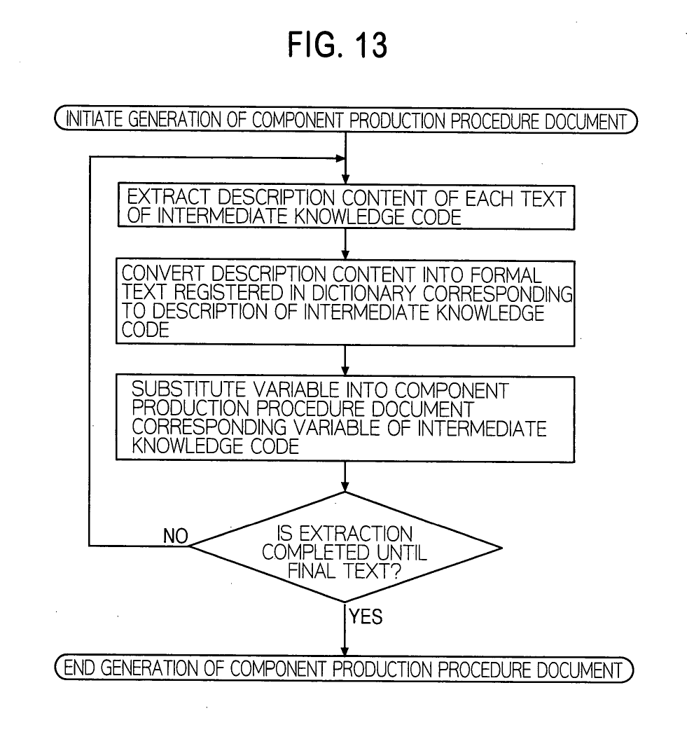

Now, a process for converting the intermediate knowledge code 22 into the component production procedure document 12 as shown in FIG. 4 will be described. The intermediate knowledge code 22 which is converted in accordance with the intermediate knowledge code converting rules in the intermediate knowledge code converting units 40, 45 is converted into the component production procedure document 12. As shown in FIG. 13, the description content of each text of the intermediate knowledge code 22 is extracted for each text and is converted into a formal text registered in the dictionary of the document description generating unit 25 which corresponds to the description of the intermediate knowledge code 22. A variable which corresponds to the variable of the intermediate knowledge code 22 is substituted with the formal text of the component production procedure document 12. The specification tree information code is extracted until the final text by repeating this process, so that the specification tree information code is converted into the intermediate knowledge code 22.

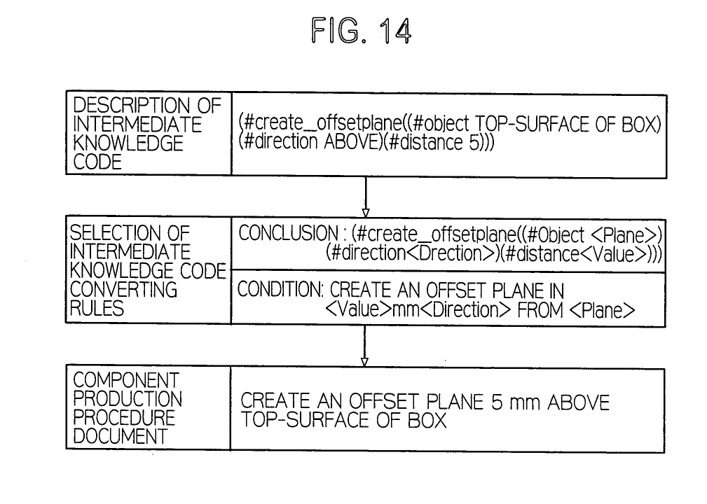

The intermediate knowledge code 22 which is described in the entry “description of intermediate knowledge code” as shown in FIG. 14 is converted into a part corresponding to a formal text described in “conclusion unit” of the entry “selection of intermediate knowledge code converting rules” and a part corresponding to a variable described in “condition unit”, which are respectively converted into the component production procedure document 12 which is described in a natural language in the entry “component production procedure document”. In such a manner, conversion of the entire of component production procedure document is completed.

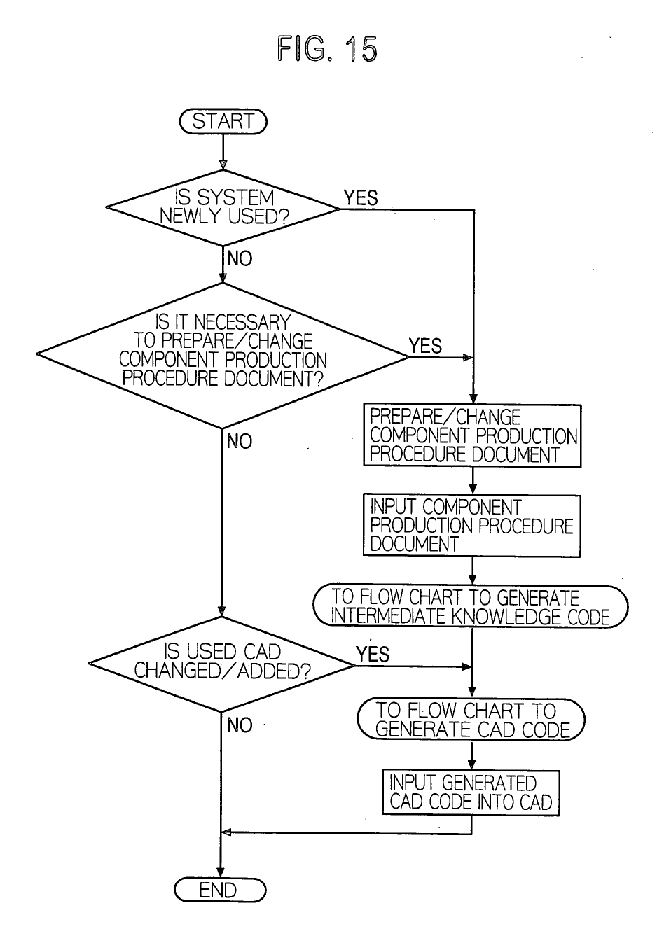

Now, A process for using the knowledge-based CAD as shown in FIG. 15 will be described. If a CAD system is newly used when the use of the knowledge-based CAD is initiated, firstly the component production procedure document 12 is prepared. The component production procedure document 12 is input to the intermediate knowledge code generation unit 20 for generating the intermediate knowledge code. The intermediate knowledge code is input to the CAD code converting unit 30 for generating the CAD knowledge code which is a knowledge code. Inputting of the component production procedure document 12 to the intermediate knowledge code generating unit 20 and inputting of the intermediate knowledge code to the CAD code converting unit 30 can be automatically carried out by modifying the program. The CAD knowledge code is input to the knowledge-based CAD for using the knowledge-based CAD.

If the knowledge-based CAD has been used for generating the CAD knowledge code by means of this system, a check is made whether there is a necessity of confirmation and verification of the content of the component production procedure document 12 and the update of the component production procedure document 12. If there is a necessity of the confirmation and update of the document 12, the component production procedure document 12 is prepared again by converting the CAD knowledge code into it and the content of the component production procedure document 12 which is described in a natural language is confirmed. The component production procedure document 12 is changed if needed. The changed component production document 12 is input to the intermediate knowledge code generating unit 20 similarly to the foregoing, so that it is converted into the intermediate knowledge code similarly to the foregoing. Then, the converted intermediate knowledge code is converted into the CAD knowledge code. The converted CAD knowledge code is input to the knowledge-based CAD.

If there is no necessity of changing the component production procedure document 12, a determination is made whether or not there is a necessity of changing the knowledge-based CAD to be used. If there is a necessity of changing the CAD, the CAD knowledge code which can be used for the knowledge-based CAD to be changed will be generated, the generation of the CAD knowledge code is conducted by reconverting the already generated CAD knowledge code into the intermediate knowledge code by using the intermediate knowledge code converting unit 40 and converting the reconverted intermediate knowledge code into the CAD knowledge code for the knowledge-based CAD to be changed.

The CAD knowledge code which is the changed knowledge code is input to the changed knowledge-based CAD for use thereof. If there is no necessity of changing or adding of the knowledge-based CAD to be used, the knowledge-based CAD is used by using already input CAD knowledge code. The component production procedure document 12 which is converted from the knowledge-based CAD can be utilized for the design work as a design document.

In the present invention, conversion of a text which is described in a natural language into a knowledge code becomes easier and a person can easily use the knowledge-based system without having to learn the knowledge relating to generating a knowledge code for every knowledge-based system. For example, designers and CAD operators can easily convert design documents which are described in a natural language into CAD codes, can efficiently utilize the knowledge-based CAD and can easily design similar components by using different knowledge-based CADs without having to learn the knowledge relating coding for every knowledge-based CAD.

In accordance with the present invention, the text description assistant system makes it possible to easily describe a text without causing omission of words and to uniform the description of the text. Therefore, the knowledge code can be positively generated from the text via the intermediate knowledge code. Furthermore, reconversion of the knowledge code into the text via the intermediate knowledge code is easy. Therefore, utilization, update and verification of the knowledge code are easily conducted with the text which is described in a natural language.

While the present invention has been disclosed in connection with the preferred embodiment thereof, it should be understood that there may be other embodiments which fall within the spirit and scope of the invention as defined by the following claims.

What is claimed is:

1. A process for generating a knowledge code which is used in a knowledge-based system comprising the steps of:
converting a text which is described in a natural language into acknowledge code; and
inputting said knowledge code into said knowledge-based system, said step of converting said text into said knowledge code comprising the steps of preparing an intermediate knowledge code which represents knowledge of an object field and does not depend on said knowledge-based system, from the description of said text which is described in a natural language in accordance with intermediate knowledge code generating rules and converting said intermediate knowledge code into said knowledge code which can be used in said knowledge-based system in accordance with said knowledge code generating rules.

2. A process for generating a knowledge code which is used in a knowledge-based CAD, comprising the steps of:
converting a design document into a knowledge code; and
inputting said knowledge code into said knowledge-based CAD, said step of converting said design document into said knowledge code comprising the steps of preparing an intermediate knowledge code which represents knowledge of a design object field and does not depend upon said knowledge-based CAD, from the description of said design document which is described in a natural language in accordance with intermediate knowledge code generating rules and converting said intermediate knowledge code into said knowledge code in accordance with said knowledge code generating rules.

3. A process for generating a knowledge code as claimed in claim 2, wherein said step of preparing said intermediate knowledge code comprises the steps of conducting a morphological analysis or syntactic analysis for the description of the design document which is described in a natural language and preparing said intermediate knowledge code which matches morphological information and syntactic information in accordance with said intermediate knowledge code generating rules based upon the morphological information or syntactic information which is obtained by said morphological analysis or said syntactic analysis.

4. A process for generating a knowledge code as claimed in claim 3, wherein at the step of converting said intermediate knowledge code into said knowledge code in accordance with said knowledge code generating rules, said knowledge code is a CAD codes used for said knowledge-based CAD, and in order to convert said intermediate presentation code into said CAD code used for a plurality of different knowledge-based CADs, said intermediate knowledge code is converted into a plurality of different CAD codes in accordance with a plurality of different knowledge-based code generating rules.

5. A process for generating a knowledge code as claimed in claim 4, wherein after the step of converting said intermediate knowledge code into said knowledge code in accordance with said knowledge code generating rules, said knowledge code is reconverted into said intermediate knowledge code by using a knowledge code compiler and further said intermediate knowledge code is converted into different knowledge codes by using different knowledge code generating rules.

6. A system for generating a knowledge code used for a knowledge-based system, comprising a knowledge code generator for converting a text which is described in a natural language into a knowledge code and a knowledge code input means for inputting said knowledge code to said knowledge-based system, said knowledge code generator including an intermediate knowledge code generating unit for generating an intermediate knowledge code which represents the knowledge of an object field and does not depend on said knowledge-based system, from the description of the text which is described in a natural language in accordance with intermediate knowledge code generating rules and a knowledge code converting unit for converting said intermediate knowledge code into a knowledge code which can be used in said knowledge-based system in accordance with knowledge code generating rules.

7. A knowledge code generating system for generating a knowledge code used for a knowledge based CAD as claimed in claim 6, wherein said knowledge code generator comprises an intermediate knowledge code generating unit for generating an intermediate knowledge code which represents the knowledge of design object field and does not depend on said knowledge-based CAD, from the description of the design document which is described in a natural language in accordance with said intermediate knowledge code generating rules and a knowledge code converting unit for converting said intermediate knowledge code into said knowledge code in accordance with said knowledge code generating rules of said knowledge-based CAD.

8. A knowledge code generating system as claimed in claim 7, wherein said intermediate knowledge code generating unit conducts a morphological analysis or syntactic analysis for the description of said design document which is described in a natural language and generates an intermediate knowledge code which matches morphologic information or syntactic information in accordance with said intermediate knowledge code generating rules based upon the morphological information or syntactic information which is obtained by said morphological analysis or said syntactic analysis.

9. A knowledge code generating system as claimed in claim 8, wherein for converting said intermediate knowledge code into a plurality of different CAD codes in accordance with a plurality of different knowledge code generating rules in said knowledge code converting unit, said intermediate knowledge code is converted into said CAD code used for a plurality of different knowledge-based CADs.

10. A knowledge code generating system as claimed in claim 9, wherein said knowledge code generator reconverts said knowledge code into said intermediate knowledge code by using a knowledge code compiler after conversion of said intermediate knowledge code into said knowledge code in accordance with said knowledge code generating rule and converts said intermediate knowledge code into different knowledge code in accordance with said knowledge code generating rule.

11. A process for producing a knowledge code which is used in a knowledge-based system, characterized in that said process comprises the steps of:
preparing a text which is described in a natural language by means of a text description assistant system;
converting said text into an intermediate knowledge code;
converting said intermediate knowledge code into a knowledge code; and
inputting said knowledge code into said knowledge-based system, and
in that said text describing assistant system is adapted to prepare said text by inputting describing items in accordance with a preliminarily provided text description procedure, said steps of converting said text into said intermediate knowledge code converts the description of a formal text into said intermediate knowledge code which corresponds to said formal text and does not depend upon said knowledge-based system, said step of converting said intermediate knowledge code into said knowledge code converts said intermediate knowledge code into said knowledge code which can be used in said knowledge-based system in accordance with knowledge code generating rules.

12. A process for converting a knowledge code used in a knowledge-based system into a text which is described in a natural language, characterized in that said knowledge code is output from said knowledge-based system, said output knowledge code being converted into said intermediate knowledge code which does not depend upon said knowledge-based system by using an intermediate knowledge code converting unit and said intermediate knowledge code being converted into said text corresponding to said intermediate knowledge code by using a document description generating unit.

13. A process for producing a knowledge code as claimed in claim 11, wherein at the steps of preparing a text which describes the knowledge of an object field in a natural language by using said text description assistant system and converting said text into said intermediate knowledge code, said process further includes the step of preparing an intermediate knowledge code which does not depend upon said knowledge base system, from the description of the text which is described in a natural language and is prepared without using said text description assistant system in accordance with intermediate knowledge code generating rules.

14. A process for generating a CAD knowledge code used in a knowledge-based CAD, characterized in that said process comprises the step of:
preparing a design procedure document which is described in a natural language by a design procedure document description assistance system; converting said design procedure document into an intermediate knowledge code, converting said intermediating code into a CAD knowledge code and inputting said CAD knowledge code into said knowledge-based CAD,
said design procedure document description assistance system being adapted to describe said design procedure document by selecting and inputting description items of said design procedure document in accordance with preliminarily provided description rules,
said step of converting said design procedure document into said representation code converting the description of said design procedure document into said intermediate knowledge code which corresponds to the description of said design procedure document and does not depend upon said knowledge-based CAD,
said step of converting said intermediate knowledge code into said knowledge code converting said intermediate knowledge code into said CAD knowledge code which can be used in said knowledge-based CAD in accordance with knowledge code generating rules.

15. A process for generating a knowledge code as claimed in claim 14, wherein said design procedure document description assistance system selects formal texts which constitute preliminarily provided design procedure document, a number of formal texts are preliminarily classified and prepared so that the design procedure document can be prepared by sequentially selecting the description procedure of said formal texts and each formal text of said design procedure document corresponds to the intermediate knowledge code.

16. A process for converting a CAD knowledge code used in a CAD knowledge-based system into a design procedure document which is described in a natural language, characterized in that said CAD knowledge code is output from said knowledge-based CAD system, said output CAD knowledge code being converted into said intermediate knowledge code which does not depend upon said knowledge-based system by using an intermediate knowledge code converting unit and said intermediate knowledge code being converted into said design procedure document comprising formal texts corresponding to said intermediate knowledge code by using a document description generating unit.

17. A process for generating a knowledge code as claimed in claim 14, wherein at the steps of preparing the design procedure document which describes the knowledge of an object field in a natural language by using the design procedure document description assistance system, and converting said design procedure document into said intermediate knowledge code, said process further comprises the step of conducting a morphological analysis or syntactic analysis of the description of said design procedure document which is prepared without using said design procedure document description assistance system and is described in a natural language and preparing said intermediate knowledge code which does not depend on said knowledge-based CAD in accordance with said intermediate knowledge code generating rules based upon morphological information or syntactic information which is obtained by said morphological analysis or syntactic analysis.

18. A process for generating CAD knowledge codes as claimed in claim 17, wherein in order to convert said intermediate knowledge code into said CAD knowledge codes used for a plurality of different said knowledge-based CADs, said intermediate knowledge code is converted into the plurality of different said CAD knowledge codes in accordance with a plurality of different knowledge code generating rules.

19. A knowledge code generating system for generating a knowledge codes used in a knowledge-based system, characterized in that
said knowledge code generating system comprises a text generating unit for preparing a text which is described in a natural language by means of a text description assistance system, an intermediate knowledge code generating unit for converting said text into an intermediate knowledge code, a knowledge code converting unit for converting said intermediate code into a knowledge code and a knowledge code input unit for inputting said knowledge code into said knowledge-based system,
said text generating unit is adapted to describe said text by using a text preparing tool which prepares a text using formal texts by inputting description items in accordance with preliminarily provided text description procedure,
said intermediate code converting unit is adapted to convert the description of said formal text of said text into said intermediate knowledge code which corresponds to said formal text and does not depend on said knowledge-based system, and
said knowledge code converting unit is adapted to convert said intermediate knowledge code into said knowledge code which can be used in said knowledge-based system by using a knowledge code generating rules.

20. A knowledge code converting system for converting a knowledge code used in a knowledge-based system into a text which is described in a natural language, characterized in that
said knowledge code converting system comprises a knowledge code output unit for outputting said knowledge code from said knowledge-based system, an intermediate knowledge code converting unit for converting said output knowledge code into an intermediate knowledge code which does not depend on said knowledge-based system and a document description generating unit for converting said intermediate knowledge code into a text including said intermediate knowledge code and corresponding formal texts, which is described in a natural language.

21. A knowledge code generating system for generating a knowledge code used in said knowledge-based system as claimed in claim 18, further comprising a unit for preparing an intermediate knowledge code which represents the knowledge of an object field and does not depend upon said knowledge-based system from the description of a text which is prepared without using said text description assistance system and is described in a natural language in accordance with an intermediate knowledge code generating rules in addition to said text generating unit for preparing the text which is described in a natural language by the text description assistance system and said intermediate knowledge code generating unit for converting said text into said intermediate knowledge code.

22. A knowledge generating system which is used in a knowledge-based CAD, comprising a design procedure document generating unit for preparing a design procedure document which is described in a natural language by a design procedure document description assistance system, and an intermediate knowledge code generating unit for converting said design procedure document into an intermediate knowledge code, a CAD code converting unit for converting said intermediate knowledge code into a CAD knowledge code and a knowledge code input unit for inputting said CAD knowledge code into said knowledge-based CAD,
said design procedure document generating unit is adapted to describe said design procedure document by using a design procedure document preparing tool for preparing a design procedure document by inputting design items in accordance with preliminarily provided description rules of the design procedure document,
said intermediate knowledge code generating unit is adapted to convert the description of said design procedure document into said intermediate knowledge code which corresponds to the description of said design procedure document and does not depend on said knowledge-based CAD, and said CAD code converting unit is adapted to convert said intermediate knowledge code into said knowledge code which can be used in said knowledge-based CAD by using a knowledge code generating rules.

23. A knowledge code generating system for generating a knowledge code as claimed in claim 22, wherein said design procedure document generating unit selects formal texts which constitute preliminarily provided design procedure document, and a number of said formal texts are preliminarily classified and prepared so that the design procedure document can be prepared by sequentially selecting the description procedure of said formal texts and each description item of said design procedure document corresponds to the intermediate knowledge code.

24. A system for converting a CAD knowledge code used in a knowledge-based CAD into a design procedure document which is described in a natural language, characterized in that said system comprises
an intermediate knowledge code converting unit for outputting said knowledge CAD code from said knowledge-based CAD to convert said CAD knowledge code into said intermediate knowledge code which does not depend on said knowledge-based CAD, and
a document description generating unit for converting said intermediate knowledge code into said design procedure document including said intermediate knowledge code and corresponding formal text.

25. A system for generating a knowledge code as claimed in claim 22, wherein in addition to the design procedure document preparing unit for preparing the design procedure document which is described in a natural language and the intermediate knowledge code generating unit for converting said design procedure document into said intermediate knowledge code, said system further comprises a unit for conducting a morphological analysis or syntactic analysis of the description of said design procedure document which is prepared without using said design procedure document description assistance system and is described in a natural language and for preparing said intermediate knowledge code which does not depend on said knowledge-based CAD in accordance with said intermediate knowledge code generating rules based upon morphological information or syntactic information which is obtained by said morphological analysis or syntactic analysis.
